(19) United States
(12) Patent Application Publication
(10) Pub. No.: US 2014/0251109 A1
(43) Pub. Date: Sep. 11, 2014

(54) Saw Blade

(71) Applicant: Milan Bozic, Solothurn (CH)

(72) Inventor: Milan Bozic, Solothurn (CH)

(73) Assignee: Robert Bosch GmbH, Stuttgart (DE)

(21) Appl. No.: 14/240,270

(22) PCT Filed: Jun. 20, 2012
(86) PCT No.: PCT/EP2012/061849

§ 371 Date: May 9, 2014

(30) Foreign Application Priority Data
Aug. 23, 2011 (DE) 10 2011 081 415.9

(51) Int. Cl. B23D 61/12

(52) U.S. Cl. CPC B23D 61/12
USPC 83/835

(57) ABSTRACT

A saw blade with saw teeth arranged along a rectilinear tooth side of a blade support. The saw blade includes at least one damping area.

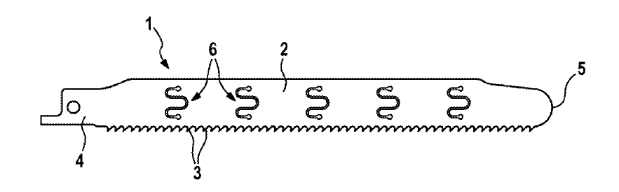

The invention relates to a saw blade, which has an at least approximately rectilinear blade carrier having saw teeth.

### PRIOR ART

There are known, for example from DE 203 16 149 U1, saw blades for compass saws having a rectilinear blade carrier, one side of which is provided with a multiplicity of saw teeth. When the compass saw is in operation, such saw blades are subjected to high loads, particularly when sawing through objects made of hard material such as, for example, metal, which may result in strong impacts upon the row of teeth. The impacts may result in a reduced efficiency of the saw blade in respect of cutting times, wear, blade breakage and shaft breakage. Moreover, the impacts are also transmitted, via the saw blade, to the housing and the handle region of the saw, and consequently also affect the user guiding the saw via the handles. The loads to which the user is subjected in this manner are statutorily regulated, and result in limitation of the duration of use.

### DISCLOSURE OF THE INVENTION

The invention is based on the object of realizing, through simple design measures, a saw blade having an at least approximately rectilinear toothed side, such that, when the saw is in operation, the loads upon the saw blade are reduced.

This object is achieved, according to the invention, through the features of claim 1. The dependent claims specify expedient developments.

The saw blade has a blade carrier having an at least approximately rectilinear toothed side, on which a multiplicity of saw teeth are disposed. The toothed side is preferably exactly rectilinear, slightly curved toothed sides also being possible in principle. The saw blade can be inserted into power tools, in particular hand-guided power tools that have a motor drive and execute an at least approximately rectilinear sawing motion. The power tool is, for example, a compass saw or saber saw having a rectilinear, oscillating saw-stroke motion.

The saw blade according to the invention has a damping zone made therein, which has the function of effectively damping loads acting upon the saw blade. The damping zone is realized as a damping opening, which is made in the blade carrier or in the shaft of the saw blade, for example by punching or cutting, such as, for example, laser cutting. The damping opening is realized, for example, as a damping slot of only small width, which ensures that the saw blade has sufficient stiffness. In particular, the length of the damping slot is significantly greater than its width. Advantageously, the walls that delimit the damping slot are parallel to each other and, when the saw blade is in non-loaded state, are a small distance apart from each other. Under load, the delimiting walls may be in contact, or they may move apart from each other as a result of bending-up of the damping slot. According to a further expedient embodiment, the walls delimiting the slot are also in contact when in the non-loaded state. The damping effect is achieved in that the walls of the damping slot are bent up.

Also possible, instead of a slot, are damping openings that have areal openings, for example round, angular, elongate, curved or other openings. The damping openings may be made only in the blade carrier, only in the shaft, or in both the blade carrier and the shaft.

In this way, a geometric damping of the saw blade is realized, which results in effective reduction of the loads acting on the saw blade, and consequently also on the user of the saw.

According to an advantageous embodiment, the damping slot is non-rectilinear, as viewed over its length, possibilities including both damping slots composed of a plurality of individual portions that are rectilinear, but disposed at an angle in relation to each other, and damping slots having curved portions. For example, the damping slot is realized in the shape of a snake, and consequently has direction components that extend both in the direction of the longitudinal axis and in the transverse direction. Realization of the damping slot with components in the longitudinal and transverse direction is advantageous, because loads acting upon the saw blade, such as impacts, are damped in an effective manner in both the longitudinal direction and in the transverse direction as a result.

The damping effect can be improved in that a plurality of damping openings are made in the blade carrier. These damping openings may be of the same kind, but dissimilar damping openings, or a combination of a plurality of same-kind and dissimilar damping openings, may also be possible.

The damping opening may extend as far as the edge of the blade carrier, i.e. either to the toothed side or to the back of the blade carrier, opposite to the toothed side. Also possible are embodiments in which the damping opening is located entirely within the blade carrier, without contacting an edge region.

According to a further advantageous embodiment, a damping filler, composed of a material differing from that of the blade carrier, is inserted in the damping opening. The damping filler is made, in particular, from a highly damping material, for example from a PUR (polyurethane) material. The damping filler is, for example, injected into the damping opening, and sets in the damping opening. Advantageously, the entire damping opening is filled by the damping filler. In the case of a plurality of damping openings in the blade carrier, all the damping openings are expediently filled with a damping filler, possibilities also including, in principle, embodiments in which only some of the damping openings are filled with a damping filler, and/or in which the damping openings are only partially filled with a damping filler.

The saw blade, advantageously, is a rectilinear, planar tool. It is also possible, however, for the planar saw blade according to the invention to be shaped to form a substantially cylindrical drilling body for a hole saw. In a preferred embodiment of such a hole saw, the planar saw blade, having at least one damping opening according to the invention, is rolled up to form a hollow cylinder. Preferably, the rolled-up planar saw blade is shaped to form the hollow cylinder by positive and/or materially bonded connection such as, for example, insert connection, latching, adhesive bonding, soldering and/or welding of both ends, or both end regions, of the saw blade to each other. This hollow cylinder then constitutes the drilling body of the hole saw. This drilling body can be connected, for example, to a base plate of the hole saw, or disposed on the base plate. In a particularly preferred embodiment, the base plate is realized as part of an adapter device for hole saws, such as those known, for example, from DE 10 2007 022 186 A1.

Further advantages and expedient embodiments are given by the further claims, the description of the figures, and by the drawing, which shows a saw blade, which is rectilinear in form and which can be used, for example, for a compass saw or saber saw.

The saw blade represented in the figure can be used for a rectilinear, oscillating saw-stroke motion, particularly in compass saws or saber saws. The saw blade 1 has a rectilinear blade carrier 2 that, on a toothed side, is provided with a multiplicity of saw teeth 3 between a clamping end 4, by means of which the saw blade 1 is clamped in a holder of the power tool, and a saw blade tip 5. When in operation, the saw blade 1 executes an oscillating stroke motion along its longitudinal axis.

Made in the blade carrier 2, distributed over its length, there are a plurality of damping slots 6, which each constitute a damping zone and, in particular, damp high, impact-like loads that act upon the saw blade 1 during operation. As a result, on the one hand, the service life of the saw blade 1 is increased and, on the other hand, the load acting on the user of the saw is also reduced, such that the user can work with the saw over a longer period of time.

A plurality of damping slots 6, which are of the same kind as each other, are made in the blade carrier 2 of the saw blade 1. The damping slots 6 are distributed over the length of the blade carrier 2. Each damping slot 6 is realized in the shape of a snake, the opposing end points of each damping slot 6 being disposed adjacently to the toothed side and to the back, respectively, of the blade carrier 2, but in each case being at a distance from the toothed side and the back of the blade carrier. Other portions of each damping slot 6 that are located between the end points are also at a distance from the toothed side and the back of the blade carrier, and are therefore located entirely within the blade carrier, at a distance from the edge region.

The damping slots 6 are made in the blade carrier 2 by, for example, punching or cutting, such as, for example, laser cutting. The walls that directly delimit the damping slot 6 are parallel to each other, and are at a distance apart from each other, corresponding to the width of the damping slot. Expediently, the damping slots 6 are filled with a damping material such as, for example, PUR.

Each snake-shaped damping slot 6 has portions that extend in the longitudinal direction of the saw blade 1, as well as further, connecting portions extending in the transverse direction. As a result, loads are damped in an effective manner in both the transverse direction and the longitudinal direction of the saw blade.

1. A saw blade comprising:
a blade carrier;
a plurality of saw teeth disposed along an at least approximately rectilinear toothed side of the blade carrier; and
at least one damping zone configured to define a damping opening.

2. The saw blade as claimed in claim 1, wherein the damping opening is defined in the blade carrier.

3. The saw blade as claimed in claim 1, wherein the damping opening is defined in a shaft of the saw blade.

4. The saw blade as claimed in claim 1, wherein a damping filler occupies at least a portion of the damping opening.

5. The saw blade as claimed in claim 4, wherein the damping filler includes a polyurethane material.

6. The saw blade as claimed in claim 1, wherein the damping opening extends as far as an edge of the blade carrier.

7. The saw blade as claimed in claim 1, wherein the damping opening is located at a distance from the an edge of the blade carrier.

8. The saw blade as claimed in claim 1, wherein the damping opening is non-rectilinear in form.

9. The saw blade as claimed in claim 8, wherein the damping opening defines a snake-like shape.

10. The saw blade as claimed in claim 1, wherein the damping opening extends through at least a portion of the saw blade in a longitudinal direction and through at least a portion of the saw blade in a transverse direction.

11. The saw blade as claimed in claim 1, wherein the damping opening is included in a plurality of damping openings defined in the blade carrier.

12. The saw blade as claimed in claim 11, wherein the dampening openings of the plurality of damping opening are each of a same kind.

13. The saw blade as claimed in claim 1, wherein the damping opening defines a damping slot.

14. The saw blade as claimed in claim 1, wherein the damping opening defines a damping area.

15. (canceled)

16. A saw blade comprising:
a substantially cylindrical blade carrier;
a plurality of saw teeth disposed along a toothed side of the substantially cylindrical blade carrier; and
at least one damping zone configured to define a damping opening.
